(19) United States
(12) Patent Application Publication
(10) Pub. No.: US 2024/0191999 A1
(43) Pub. Date: Jun. 13, 2024

(54) SYSTEM AND METHOD FOR GENERATING NAVIGATION INSTRUCTIONS

(71) Applicant: HERE Global B.V., Eindhoven (NL)

(72) Inventors: Jingwei XU, Buffalo Grove, IL (US); Yuxin GUAN, Chicago, IL (US); Leon STENNETH, Chicago, IL (US); Bruce BERNHARDT, Wauconda, IL (US); Advait Mohan RAUT, Virar West (IN); Weimin HUANG, Chicago, IL (US)

(21) Appl. No.: 18/077,049

(22) Filed: Dec. 7, 2022

(51) Int. Cl. G01C 21/34; G01C 21/36

(52) U.S. Cl. CPC G01C 21/3415; G01C 21/343; G01C 21/3667; G01C 21/3691

(57) ABSTRACT

A system, a method, and a computer program product may be provided for generating navigation instructions. The system may include a memory configured to store computer executable instructions and a processor configured to execute the computer executable instructions to retrieve sensor data associated with at least one vehicle travelling along a route having at least one intersection and map data associated with the route from a map database. The sensor data indicates intersection information relating to the at least one intersection. The intersection information comprises an intersection category and an intersection type. The map data comprises traffic-related information for a plurality of intersection connected links. The processor may be further configured to determine a turn cost correction factor for the at least one intersection, based on the sensor data and the map data. The processor may be further configured to store the turn cost correction factor within the map database.

### TECHNOLOGICAL FIELD

The present disclosure generally relates to mapping and navigation systems, and more particularly relates to generating accurate navigation instructions in mapping and navigation systems.

### BACKGROUND

In navigation systems, it is crucial to provide accurate navigation instructions for reliable routing of a vehicle. The navigation instructions may be delivered to the vehicle or user equipment associated with the vehicle via, for example, radio interfaces, and the Internet. In an example, the generated navigation instructions may be provided as flow or incident messages such that the flow or incident messages indicate an estimated time of arrival (ETA) of the vehicle at a destination.

However, due to the unpredictability and complexity of road traffic conditions, ETA estimation may require pre-knowledge of traffic information of each road segment and dynamic traffic situation changes along a predefined route. Consequently, an accurate ETA for the vehicle may not be determined.

### BRIEF SUMMARY

In order to generate the navigation instructions, traffic information, such as real-time probe data and map artifact data may be taken as input. Upon receiving the map artifact data and the real-time probe data, certain processing steps may be processed to generate the navigation instructions as output. The processing may include steps of map matching, pathing, and the like. In an example, based on real-time and predicted traffic conditions, travel speed on a road segment, road condition of the road segment, the road segment may be described as one of free flow, queuing, stationary, closed, etc. Subsequently, ETA may be estimated when crossing the road segment.

Although, estimation of the accurate ETA is straightforward when travel time for each of the road segments and transition time between the two adjacent connected road segments are calculated accurately. However, the accurate estimation of ETA gets complicated owing to complexity in predicting traffic conditions at intersections between links. Accordingly, there is a need for a reliable system to analyze dynamic traffic conditions, specifically, dynamic traffic when crossing an intersection to generate navigation instructions accurately.

A system, a method, and a computer program product are provided herein that focuses on generating navigation instructions. In one aspect, the system for generating the navigation instructions may be provided. The system may include at least one non-transitory memory configured to store computer program code; and at least one processor (hereinafter referred as processor) configured to execute the computer program code to retrieve sensor data associated with at least one vehicle travelling along a route having at least one intersection. The sensor data indicates intersection information relating to at least one intersection. The intersection information includes at least one of an intersection category and an intersection type. In accordance with an embodiment, the processor may be configured to retrieve map data associated with the route having at least one intersection. The map data includes information from a map database. The map data indicates traffic-related information for a plurality of intersection connected links. In accordance with an embodiment, the processor may be configured to determine a turn cost correction factor for the at least one intersection, based on the sensor data and the map data. In accordance with an embodiment, the processor may be configured to store the turn cost correction factor within the map database.

According to some example embodiments, the processor may be further configured to update navigation instructions of a first vehicle travelling along the route based on the turn cost correction factor, wherein the first vehicle is to cross the at least one intersection.

According to some example embodiments, the processor may be further configured to determine a first estimated time of arrival (ETA) of the first vehicle and update the first ETA based on the turn cost correction factor for each of the at least one intersection. The first ETA may be determined based on the sensor data and the map data. The updating the first ETA comprises adding or multiplying the turn cost correction factor for each of the at least one intersection to the determined first ETA.

According to some example embodiments, the processor may be further configured to determine driving path on a lane level of the first vehicle when crossing the at least one intersection and determine a first travel time corresponding to each of the at least one intersection based on the intersection type, the intersection category and the driving path.

According to some example embodiments, the processor may be further configured to determine traffic speed data associated with a plurality of links connected by the at least one intersection based on the map data and determine a second travel time corresponding to each of the at least one intersection based on the determined traffic speed data.

According to some example embodiments, the processor may be further configured to determine the turn cost correction factor for each ingress lane(s) to egress lane(s) of the at least one intersection, based on a difference between the first travel time at the at least one intersection and the second travel time at the corresponding at least one intersection.

According to some example embodiments, the map data includes at least one High Definition (HD) map attributes, link attributes, and dynamic event information.

According to some example embodiments, the sensor data includes but not limited to at least one of traffic light information, stop sign information, traffic sign information, lane marking information, pedestrian image, time stamp, cone, and geolocation data.

According to some example embodiments, the processor may be configured to update the map database based on the turn cost correction factor.

Embodiments disclosed herein may provide a method for determining navigation instructions. The method may include retrieving sensor data associated with at least one vehicle travelling along a route having at least one intersection. The sensor data indicates intersection information relating to at least one intersection, and the intersection information includes at least one of an intersection category and an intersection type. The method may include retrieving map data associated with the route having at least one intersection, wherein the map data comprises information from a map database. The map data indicates traffic-related information for a plurality of intersection connected links. The method may include determining a turn cost correction factor for the at least one intersection, based on the sensor data and the map data; and storing the turn cost correction factor within the map database.

According to some example embodiments, the method may further include updating navigation instructions of a first vehicle travelling along the route based on the turn cost correction factor, wherein the first vehicle is to cross the at least one intersection.

According to some example embodiments, the method may further include determining a first estimated time of arrival (ETA) of the first vehicle based on the sensor data and the map data; and updating the first ETA based on the turn cost correction factor for each of the at least one intersection. The updating the first ETA comprises adding or multiplying the turn cost correction factor for each of the at least one intersection to the determined first ETA.

According to some example embodiments, the method may further include determining driving path on the lane level of the first vehicle when crossing the at least one intersection; and determining a first travel time corresponding to each ingress lane(s) to egress lane(s) of the at least one intersection based on the intersection type, the intersection category and the driving path.

According to some example embodiments, the method may further include determining traffic speed data associated with a plurality of links connected by the at least one intersection based on the map data; and determining a second travel time corresponding to each of the at least one intersection based on the determined traffic speed data.

According to some example embodiments, the method may further include determining the turn cost correction factor for each ingress lane(s) to egress lane(s) of the at least one intersection, based on a difference between the first travel time at the at least one intersection and the second travel time at the corresponding at least one intersection.

According to some example embodiments, the map data comprises at least one of High Definition (HD) map attributes, link attributes, and dynamic event information.

Embodiments of the present disclosure may provide a computer programmable product including at least one non-transitory computer-readable storage medium having computer-executable program code stored therein. The computer programmable product comprising a non-transitory computer readable medium having stored thereon computer executable instructions, which when executed by a computer, cause the computer to carry out operations, for generating navigation instructions. The operations include retrieving sensor data associated with at least one vehicle travelling along a route having at least one intersection and retrieving map data associated with the route having at least one intersection. The sensor data indicates intersection information relating to at least one intersection, wherein the intersection information includes at least one of an intersection category and an intersection type. The map data includes information from a map database, wherein the map data indicates traffic-related information for a plurality of intersection connected links. The operations include determining a turn cost correction factor for the at least one intersection based on the sensor data and the map data; and storing the turn cost correction factor within the map database.

According to some example embodiments, the operations may further include updating navigation instructions of a first vehicle travelling along the route based on the turn cost correction factor, wherein the first vehicle is to cross the at least one intersection.

According to some example embodiments, the operations may further include determining a first estimated time of arrival (ETA) of the first vehicle based on the sensor data and the map data; and updating the first ETA based on the turn cost correction factor for each ingress lane(s) to egress lane(s) of the at least one intersection. The updating the first ETA includes adding or multiplying the turn cost correction factor for each ingress lane(s) to egress lane(s) of the at least one intersection to the determined first ETA. The operations may further include determining traffic speed data associated with a plurality of links connected by the at least one intersection based on the map data; and determining a second travel time corresponding to each ingress lane(s) to egress lane(s) of the at least one intersection, based on the determined traffic speed data.

According to some example embodiments, the operations may further include determining the turn cost correction factor for each ingress lane(s) to egress lane(s) of the at least one intersection, based on a difference between the first travel time at the at least one intersection and the second travel time at the corresponding at least one intersection.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 is a block diagram that illustrates a network environment of a system implemented for generating navigation instructions, in accordance with an example embodiment;

FIG. 2A illustrates a block diagram of a system for generating navigation instructions, in accordance with one or more example embodiments;

FIG. 2B illustrates an exemplary format of map data stored in a map database in accordance with one or more example embodiments;

FIG. 2C illustrates another exemplary format of the map data stored in the map database, in accordance with one or more example embodiments;

FIG. 2D illustrates an exemplary map database storing map data for generating navigation instructions, in form of attributes shown in FIGS. 2B and 2C, in accordance with one or more example embodiments;

FIG. 3 shows a graphical representation of an exemplary environment where a turn cost correction factor corresponding to an intersection is calculated, in accordance with an example embodiment; and

FIG. 4 illustrates a flowchart for implementation of an exemplary method to generate navigation instructions, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### Definitions

The term “road” may refer to a way leading a traveler from one location to another. The road may have a single lane or multiple lanes.

The term “lane” may refer to a part of a road that is designated for travel of vehicles or pedestrians as per some condition.

The term “link” may refer to any connecting pathway including, but not limited, to a roadway, a highway, a freeway, an expressway, a lane, a street path, a road, an alley, a controlled access roadway, a free access roadway and the like.

The term “route” may refer to a path from a source location to a destination location on any link.

The term “navigation instructions” may refer to one or more set of instructions for navigating from a source location to a destination location. For example, the navigation instructions may indicate one or more instructions depending on different transport vehicle options, such as private and public transport vehicles. The navigation instructions may also indicate a best possible way for travelling from the source location to the destination location depending on, for example, traffic conditions, road conditions, public vehicle options, private vehicle options, and so forth. In an example, the navigation instructions may also include textual instructions with all relevant navigation information, one or more flow or incident routing messages or alerts, estimated time of arrival (ETA) at the destination location, distance to travel, map icons, traffic information along the route, and other settings and route-related information.

The term “estimated time of arrival (ETA)” may refer to an estimated time of arrival of a vehicle, at a destination location. In an example, the ETA for a vehicle may be determined based on movement of the vehicle, type of the vehicle, and traffic intensity or traffic conditions on the route travelled by vehicle. The determination of the ETA may also be dependent on estimated time of departure (ETD) form a source location. The ETA information of the vehicle may be conveyed to a person associated with the vehicle as part of navigation instructions that forms core functionality of intelligent transportation systems.

### End of Definitions

A system, a method, and a computer program product are provided herein in accordance with an example embodiment for generating navigation instructions. The system, the method, and the computer program product disclosed herein provide accurate navigation instructions, specifically, accurate ETA when travelling along a route that has one or more intersections. The system, the method, and the computer program product disclosed herein facilitates advanced use of sensor data collected from probe devices and probe vehicles (collectively referred to as, probe resources) in order to improve ETA estimation and navigation instructions for transportation implementations.

The system, the method, and the computer program product disclosed herein may be configured to determine prediction of traffic conditions on several links as well as intersections between the links that may lie in between a source location and a destination location. The system, the method, and the computer program product disclosed herein may be configured to determine intersection turn cost correction factor data for an intersection to accurately estimate time for crossing the intersection. Based on the intersection turn cost correction factor data for each of the intersection lying in between the source location and the destination location, accurate navigation instructions and accurate ETA may be generated for routing a vehicle.

The system, the method, and the computer program product disclosed herein may be configured to update the map data based on the determined navigation instructions. The system, the method, and the computer program product disclosed herein may further provide a notification message associated with the navigation instructions for a route. For example, the notification message may inform a vehicle or user equipment with up-to-date map data for the route, such as updated ETA, reconfigured routing information, and so forth. Alternatively, the available up-to-date data may be pushed as an update to the vehicle or the user equipment. These and other technical improvements of the present disclosure will become evident from the description provided herein.

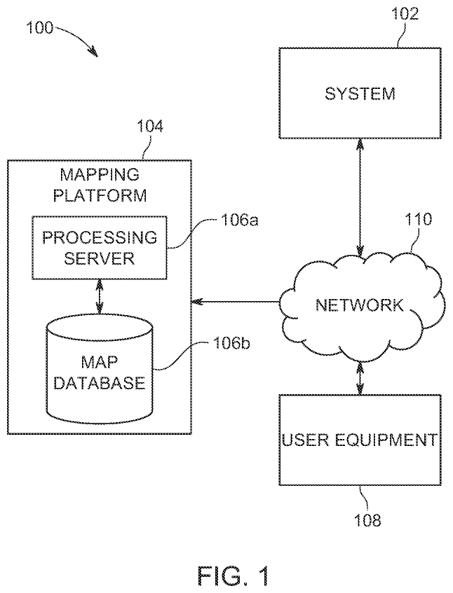

FIG. 1 is a block diagram that illustrates a network environment 100 of a system 102 implemented for generating navigation instructions, in accordance with an example embodiment. As shown in FIG. 1, the network environment 100 may include the system 102, and a mapping platform 104. The mapping platform 104 may further include a processing server 106a and a map database 106b. The network environment 100 may further include a user equipment (UE) 108 and a network 110. The UE 108 may include an application and a user interface (not shown in the FIG. 1).

In an embodiment, the system 102 may be coupled to one or more user equipment, for example, as a part of an in-vehicle navigation system, a navigation app in a mobile device and the like. In this regard, the system 102 may be communicatively coupled to the components shown in FIG. 1 to carry out the desired operations and wherever required modifications may be possible within the scope of the present disclosure.

In some example embodiments, the user equipment 108 may be any user accessible device such as a mobile phone, a smartphone, a portable computer, and the like that are portable in themselves or as a part of another portable/mobile object such as the vehicle. The user equipment 108 may comprise a processor, a memory, and a communication interface. The processor, the memory, and the communication interface may be communicatively coupled to each other. In some example embodiments, the user equipment 108 is associated, coupled, or otherwise integrated with a vehicle, such as an advanced driver assistance system (ADAS), a personal navigation device (PND), a portable navigation device, an infotainment system and/or other device that may be configured to provide route guidance and navigation related functions to the user. In such example embodiments, the user equipment 108 comprises processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the user equipment 108. For example, the user equipment 108 may be configured to execute and run mobile applications such as a messaging application, a browser application, a navigation application, and the like. In some embodiments, the system 102 may be implemented in the UE 108.

In one embodiment, the user equipment 108 may be directly coupled to the system 102 via the network 110. In another embodiment, the user equipment 108 may be coupled to the system 102 via an OEM (Original Equipment Manufacturer) cloud and the network 110. For example, the user equipment 108 may be a consumer vehicle (or a part thereof) and may be a beneficiary of the services provided by the system 102. In some example embodiments, the user equipment 108 may serve the dual purpose of a data gatherer and a beneficiary device. In an example, the user equipment 108 may be installed in a vehicle and is configured to detect feature lines and traffic conditions on links and/or road segments by using image based sensors installed in the vehicle. The user equipment 108 then sends the detected data to the system 102, which processes the detected data to generate navigation instructions for routing.

In an example embodiment, the system 102 may be onboard a vehicle, such as the system 102 may be a navigation system installed in the vehicle for generating navigation instructions. In an example, the vehicle may be an autonomous vehicle, a semiautonomous vehicle, or a manually operated vehicle. In another example embodiment, the system 102 may be the server 106a of the mapping platform 104, and therefore may be co-located with or within the mapping platform 105. For example, the system 102 may be embodied as a cloud based service, a cloud based application, a cloud based platform, a remote server based service, a remote server based application, a remote server based platform, or a virtual computing system. In yet another example embodiment, the system 102 may be an OEM (Original Equipment Manufacturer) cloud. The OEM cloud may be configured to anonymize any data received by the system 102, such as from the user equipment 108 or a vehicle, before using the data for further processing, such as before sending the data to map database 106b. In an example, anonymization of the data may be done by the mapping platform 104.

The system 102 may be communicatively coupled to the UE 108 and the mapping platform 104, via the network 110. In an embodiment, the system 102 may be communicatively coupled to other components not shown on FIG. 1 via the network 110. The network 110 may be wired, wireless, or any combination of wired and wireless communication networks, such as cellular, Wi-Fi, internet, local area networks, or the like. In some embodiments, the network 103 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

All the components in the network environment 100 may be coupled directly or indirectly to the network 110. The components described in the network environment 100 may be further broken down into more than one component and/or combined together in any suitable arrangement. Further, one or more components may be rearranged, changed, added, and/or removed.

The system 102 may comprise suitable logic, circuitry, and interfaces that may be configured to generate navigation instructions for travelling along a route. The system 102 may be configured to retrieve sensor data and map data corresponding to the route from the map database 106b. The route may lie in between a source location and a desired destination location. In addition, the route may have a plurality of links and at least one intersection that may connect two of the plurality of links on the route. The plurality of intersection connected links may form a driving path (on lane level) of a vehicle for reaching the desired destination location from the source location.

The mapping platform 104 may comprise suitable logic, circuitry, and interfaces that may be configured to store one or more map attributes associated with road network. The mapping platform 104 may be configured to store and update map data indicating the map attributes, in the map database 106b. The mapping platform 104 may include techniques related to, but not limited to, geocoding, routing (multimodal, intermodal, and unimodal), clustering algorithms, machine learning in location based solutions, natural language processing algorithms, and artificial intelligence algorithms. Data for different modules of the mapping platform 104 may be collected using a plurality of technologies including, but not limited to drones, sensors, connected cars, cameras, probes, and chipsets. In some embodiments, the mapping platform 104 may be embodied as a chip or chip set. In other words, the mapping platform 104 may comprise one or more physical packages (such as, chips) that includes materials, components and/or wires on a structural assembly (such as, a baseboard).

In some example embodiments, the mapping platform 104 may include the processing server 106a for carrying out the processing functions associated with the mapping platform 104 and the map database 106b for storing map data. In an embodiment, the processing server 106a may comprise one or more processors configured to process requests received from the system 102. The processors may fetch sensor data and/or map data from the map database 106b and transmit the same to the system 102 in a format suitable for use by the system 102. In some example embodiments, as disclosed in conjunction with the various embodiments disclosed herein, the system 102 may be used to generate navigation instructions for routing along a route using the sensor data and map data corresponding to the route.

Continuing further, the map database 106b may comprise suitable logic, circuitry, and interfaces that may be configured to store sensor data and map data, which may be collected from at least one vehicle traveling on a link on a route, or in a region close to the route, or on another route related to the route. In an example, the mapping platform 104 may receive the sensor data and fuse the sensor data to infer intersection information associated with at least one intersection on the route in which probes or fleeting vehicles are moving. In accordance with an embodiment, such sensor data may be updated in real time or near real time such as within a few seconds, a few minutes, or on hourly basis, to provide accurate and up to date sensor data. The sensor data may be collected from any sensor that may inform the mapping platform 104 or the map database 106b of features within an environment that are appropriate for traffic related services. In accordance with an embodiment, the sensor data may be collected from any sensor that may inform the mapping platform 104 or the map database 106b of features within an environment that are appropriate for mapping. For example, motion sensors, inertia sensors, image capture sensors, proximity sensors, LIDAR (light detection and ranging) sensors, and ultrasonic sensors may be used to collect the sensor data. The gathering of large quantities of crowd-sourced data may facilitate the accurate modeling and mapping of an environment, whether it is a road link or a link within a structure, such as in an interior of a multi-level parking structure.

In accordance with an embodiment, the map database 106b may be configured to receive, store and transmit sensor data (such as, car data) that may be collected from consumer vehicles travelling on links throughout a geographic region (or a region), or along a route. In accordance with another embodiment, a map developer may employ field personnel to travel by a vehicle along links throughout the route to observe features and/or record information. The map developers may crowd source geographic map data (or the map data) and vehicle sensor data (or the sensor data) to determine turn correction cost factor relating to the at least one intersection and generate, or update the navigation instructions. In accordance with an embodiment, the sensor data may include, but not limited to, intersection image, intersection video, vehicle-to-vehicle (V2V) data, vehicle-to-infrastructure (V2I) data, traffic light information, stop sign information, traffic sign information, lane marking information, pedestrian image, time stamp, cone, and geolocation data.

In accordance with an example embodiment, the sensor data may be a part of probe data retrieved from probe resources travelling on road. In some example embodiments, the map database 106b may also be configured to receive, store and transmit probe data including positional, speed, and temporal data. The probe data may be used to determine traffic volume associated with movement of one or more vehicles on the plurality of links on the route. The traffic volume on the plurality of links may correspond to the one or more vehicles on each of the plurality of links for a given time period. The probe count from the probe data may be observed within the given time period and projected to determine the traffic volume for that given time period. In accordance with an embodiment, the probe data may include, but are not limited to, real time speed (or individual probe speed), incident data on the road, road closure and construction data, traffic signal timing data, geolocation data, timestamp data, and historical recurring traffic congestion pattern data.

The map database 106b may further be configured to store the traffic-related data and road topology and geometry-related data for a road network as map data. The map data may also include cartographic data, routing data, and maneuvering data. The map data may also include, but not limited to, locations of intersections, diversions to be caused due to the heavy congestion, suggested roads or links to avoid heavy congestion, ETAs depending on different links. In accordance with an embodiment, the map database 106b may be configured to receive the map data including the traffic-related attributes and the road topology and geometry-related attributes related to the road network from external systems, such as, one or more of background batch data services, streaming data services and third party service providers, via the network 110.

In accordance with an embodiment, the map data stored in the map database 106b may further include data about changes in traffic situation registered by GPS provider(s), such as, but not limited to, incidents, road repairs, heavy rains, snow, fog, holiday or other events which may have influence on the traffic condition of a road in the route, time of day, day of week, holiday, etc.

In some embodiments, the map database 106b may further store historical probe data for events (such as, but not limited to, traffic incidents, construction activities, scheduled events, and unscheduled events) associated with Point of Interest (POI) data records or other records of the map database 106b.

For example, the data stored in the map database 106b may be compiled (such as into a platform specification format (PSF)) to organize and/or processed for generating navigation-related functions and/or services, such as route calculation, route guidance, map display, speed calculation, distance and travel time functions, navigation instruction generation, and other functions, by a navigation device, such as the UE 108. The navigation-related functions may correspond to vehicle navigation, pedestrian navigation, navigation to a favored parking spot or other types of navigation. While example embodiments described herein generally relate to vehicular travel, example embodiments may be implemented for bicycle travel along bike paths, boat travel along maritime navigational routes, etc. The compilation to produce the end user databases may be performed by a party or entity separate from the map developer. For example, a customer of the map developer, such as a navigation device developer or other end user device developer, may perform compilation on a received map database 106b in a delivery format to produce one or more compiled navigation databases.

In some embodiments, the map database 106b may be a master geographic database configured on the side of the system 102. In accordance with an embodiment, a client-side map database may represent a compiled navigation database that may be used in or with end user devices (e.g., the UE 108) to provide navigation instructions based on the turn cost for intersections, the traffic conditions, speed adjustment, ETAs, and/or map-related functions to navigate through the intersection connected links on the route.

Optionally, the map database 106b may contain lane and intersection data records or other data that may represent link in the route, pedestrian lane or areas in addition to or instead of the vehicle road record data. The lanes and intersections may be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, and parks. The map database 106b may additionally include data about places, such as cities, towns, or other communities, and other geographic features such as, but not limited to, bodies of water, and mountain ranges.

In case of modern day navigation services which are based on high definition maps and real-time probe data for providing navigation instructions, it becomes critical to provide navigation instructions with accuracy, clarity and precision. In accordance with an embodiment, several factors, such as flow, incident, weather information, traffic light, time of the day, day of the week, other dynamic factors, etc., may be used for determining navigation instructions. Typically, real-time probe data from multiple probe resources and map data are ingested as input to generate flow or incident messages as output.

However, owing to complexity associated with prediction of traffic conditions and traffic volume, generating accurate navigation instructions and estimation of accurate ETA is very challenging. To generate the navigation instructions, the pre-knowledge of traffic information of each link is required. However, the dynamic traffic situation changes along any predefined route. Moreover, the real-time probe data received from the probe resources may have different report sampling period. Such sampling period of receiving the probe data may vary from seconds to minutes, or more. As a result, latency may get added to the whole traffic reporting system thereby hampering generation of navigation instructions. Further, multiple factors may affect a turn cost of an intersection, i.e., cost of travelling across an intersection, such as time spent in making a turn to cross the intersection, quality of road, etc. In this regard, Signal Phase and Timing (SPaT) information that defines traffic signal light phases corresponding to an intersection may play a major role. However, low frequency of probe data causes loss of information, thereby affecting turn cost calculation of the intersection. It may be noted, complexity of each intersection makes it difficult to determine turn cost of different intersections having different intersection types. In certain cases, conventional navigation systems for estimation of travel time and generation of navigation instructions may ignore the turn cost for different intersections on a route. To such an end, the conventional navigation systems fail to determine accurate turn cost for determining precise navigation instructions and ETA.

In certain cases, it may be crucial to have knowledge of exact ETA, for example in operations relating to logistics industry for high priority or time-sensitive deliveries. Moreover, it may be crucial to have road traffic information corresponding to each of intersection connected links on a route and the intersection to easily travel through the route and avoid traffic congestion, wherever possible. Therefore, it becomes crucial to generate accurate navigation instructions that precisely indicates best possible route for traveling such that time of travel is minimum along the determined route. In accordance with an embodiment of the present disclosure, high frequency, such as five samples per second, sensor data may be used to determine intersection turn cost accurately and improve the turn cost determination accuracy by comparing with traffic feeds for delta correction. Advanced planning and coordination based on accurate real-time navigation instructions may allow drivers to develop and deploy optimal operational strategies. Such capabilities may allow drivers to ensure on-time arrival, thereby avoiding any delays owing to inappropriately generated navigations instructions and inconsistent ETAs.

The embodiments disclosed herein addresses the aforementioned problems relating to conventional ETA estimation techniques and navigation instructions generation techniques. The embodiments disclosed herein estimates ETA accurately by considering turn cost at intersections, thereby generating precise navigation instructions.

In operation, the system 102 may be configured to retrieve sensor data associated with at least one vehicle travelling along a route having the at least one intersection. The sensor data may enable identification of intersection information of at least one intersection on the route. The at least one vehicle may include, but not limited to, a bus, a taxi, and a car. In accordance with an embodiment, the route may be provided by a first vehicle that has to travel on the route to reach a desired destination location. In accordance with another embodiment, the determination of the route may also be initiated autonomously by the system 102, based on a desired destination location. In accordance with an embodiment, any machine learning technique (such as, deep machine learning technique) may be used to identify the at least one vehicle travelling along the route, or on a link on the route or relating to the route.

In an example, the system 102 may retrieve the sensor data from the map database 106b, or by querying the processing server 106a. In some example embodiments, the system 102 may communicate directly with the at least one vehicle, for example, via the network 110 and/or the mapping platform 104, to retrieve the sensor data. In this regard, the sensor data may also be stored in the map database 106b.

The system 102 may be further configured to determine intersection information relating to the at least one intersection, based on the sensor data. In accordance with an embodiment, the intersection information may include, but is not limited to, an intersection category and an intersection type.

Further, the system 102 may be configured to retrieve map data associated with the route having the at least one intersection. The system 102 may retrieve the map data associated with the route from the map database 106b, or by querying the processing server 106a. In accordance with an embodiment, the map data includes traffic-related information for a plurality of intersection connected links. The plurality of intersection connected links may lie on the route to be travelled by the first vehicle. In an example, the map data may also include road topology and road geometry information relating to the plurality of intersection connected links (referred to as “links”, hereinafter) and the at least on intersection (referred to as “intersection”, hereinafter).

The system 102 may be configured to determine a turn cost correction factor for the intersection on the route, based on the sensor data and the map data. In accordance with an embodiment, the system 102 may be configured to determine a dynamic first travel time based on the high frequency sensor data and the intersection information. The system 102 may be configured to determine a historical second travel time based on the map data travel feed. The system 102 may then determine the turn cost correction factor, based on the first travel time and the second travel time. In accordance with an embodiment, the turn cost correction factor may also be based on a count of the one or more vehicles on the links and the intersection on the route and road capacity data.

In accordance with an embodiment, the system 102 may be further configured to store the turn cost correction factor within the map database 106b. In accordance with an embodiment, the system 102 may update and store map data corresponding to the intersection, based on the corresponding turn cost correction factor. In an example, the system 102 may further generate updated navigation instructions for navigating on the route, based on the turn cost correction factor for the intersection.

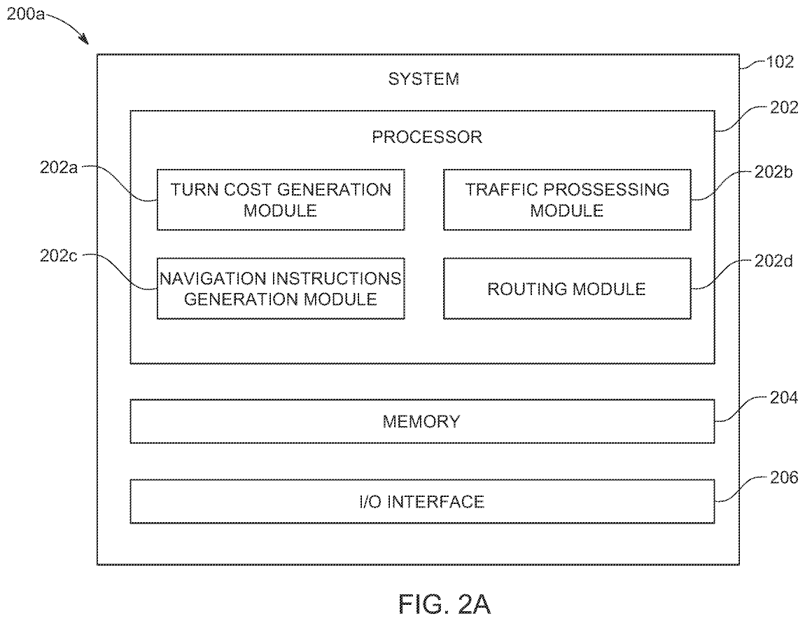

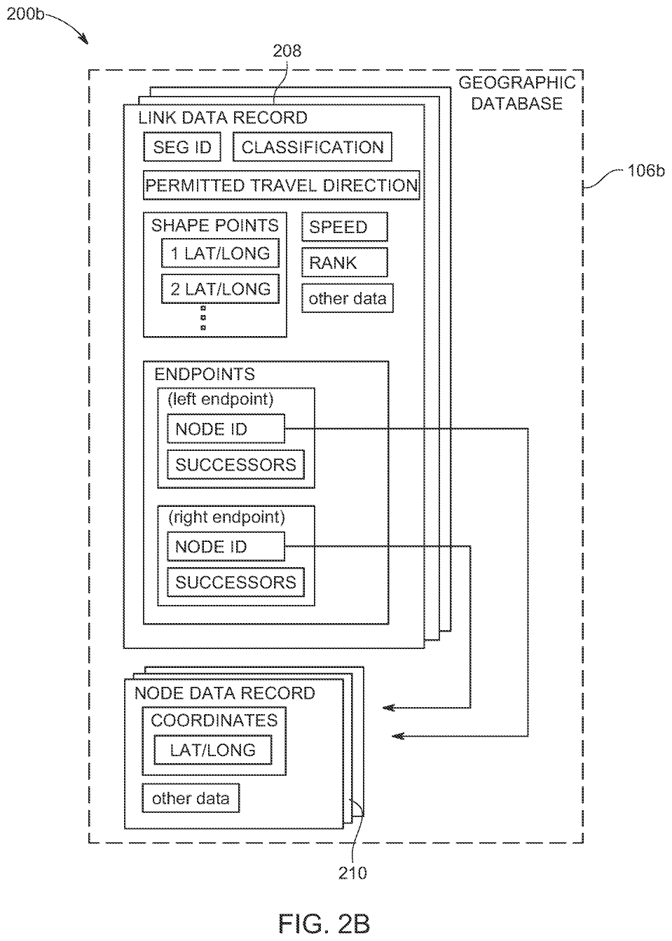

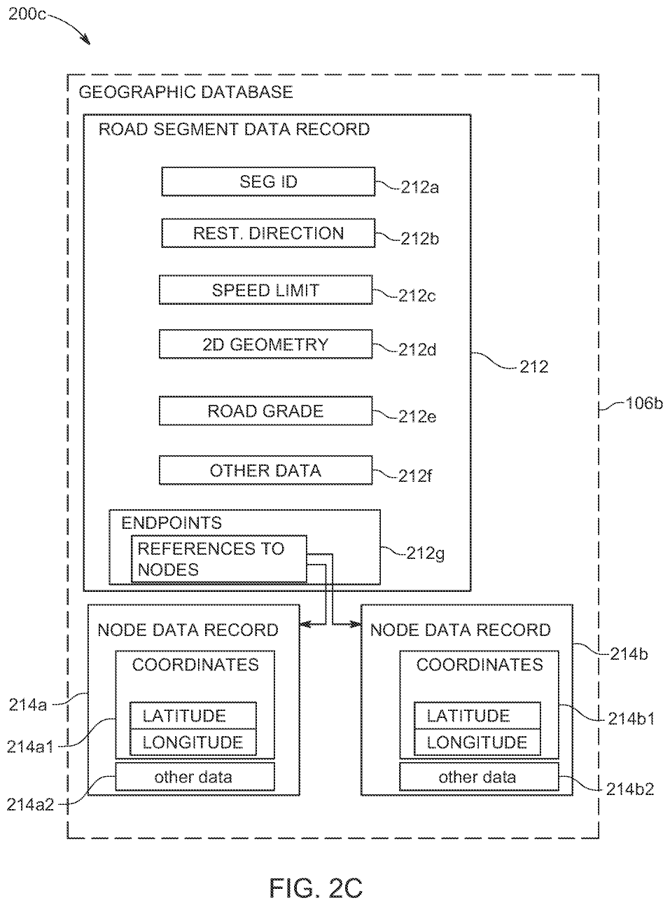

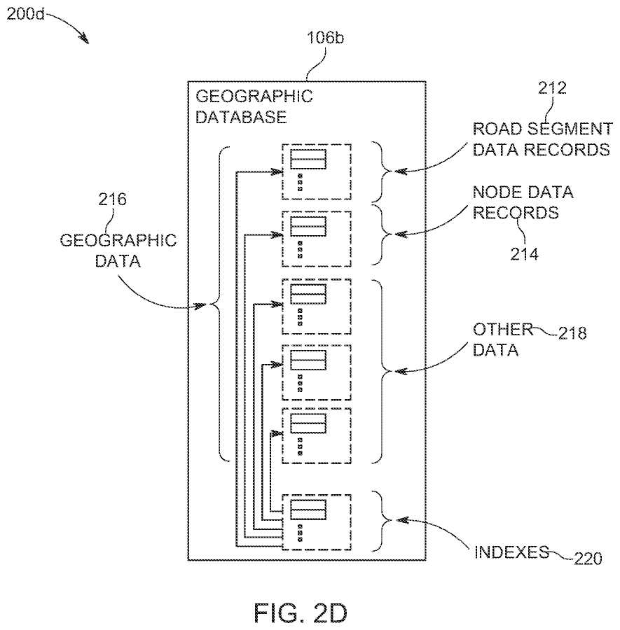

FIG. 2A illustrates a block diagram 200a of the system 102, exemplarily illustrated in FIG. 1 that may be used for generating navigation instructions, in accordance with an example embodiment. FIG. 2A is explained in conjunction with FIG. 1.

The system 102 may include at least one processor 202, a memory 204, and an I/O interface 206. The at least one processor 202 may comprise modules, depicted as a turn cost generation module 202a, a traffic processing module 202b, a navigation instructions generation module 202c, and a routing module 202d.

In accordance with an embodiment, the system 102 may store data that be generated by the modules while performing corresponding operation, or may be retrieved from a database associated with the system 102. In an example, the data 412 may include sensor data, map data, probe data, intersection turn cost correction factor, and navigation instructions.

The traffic processing module 202b may be configured to determine traffic flow or incident traffic across intersection connected links and intersections on a route of travel to a destination location. In accordance with an embodiment, the traffic processing module 202b may aggregate real-time probe data received from probe resources, such as probe vehicles and probe devices, and map data. The map data may describe road segment topology and geometry. The traffic processing module 202b may perform steps of processing, such as map matching, pathing, etc., on the input data to generate an estimate of travel speed data for a given road segment on the route. In this manner, the navigation instructions generation module 202c generates first navigation instructions for routing a vehicle along the route. In this regard, the navigation instructions generation module 202c may calculate a first ETA for the vehicle based on the first navigation instructions.

Further, the turn cost generation module 202a may be configured to determine a turn cost correction factor for each ingress lane(s) to egress lane(s) of the intersections on the route. Based on the turn cost correction factor of each ingress lane(s) to egress lane(s) of the intersections, the first navigation instruction may need to be updated.

Continuing further, the turn cost generation module 202a determines a driving path on the lane level of a first vehicle when crossing the intersection. In accordance with an embodiment, the driving path may indicate a turn to be taken by the first vehicle at an intersection to stay on the route for travelling from a source location to a desired destination location. In an example, the driving path may indicate that the first vehicle is to take one of a right-turn at the intersection, a left-turn at the intersection, a U-turn at the intersection, or drive straight through the intersection.

It may be noted that the sensor data retrieved from vehicles travelling across the intersection on the route indicates intersection information corresponding to the intersection. In accordance with an embodiment, the intersection information may include, but is not limited to, intersection type, intersection category, intersection identifier, and intersection surrounding condition information. The intersection identifier may uniquely identify the intersection thereby enabling retrieving of map data, probe data, and/or other historic data relevant to the intersection. The intersection type may indicate a type of the intersection, such as three-way intersection, four-way intersection, five-way intersection, six-way intersection, staggered intersection, and the like. Moreover, the intersection category may indicate a category of the intersection that may include, but are not limited to, highway, ramp, controlled intersection, uncontrolled intersection, traffic circle, roundabout, underpass, overpass, over bridge, exit, four-way intersection with red cycle on traffic light phase, four-way intersection with free flow traffic conditions, and the like. Further, the intersection surrounding condition information may include, but are not limited to, pedestrians crossing, traffic sign, traffic signal, volume of pedestrians at the intersection, width of the intersection, capacity of the intersection, load of the intersection, and so forth.

Based on the driving path of ingress lane(s) to egress lane(s) connection and the intersection information, the turn cost generation module 202a may determine a dynamic first travel time corresponding to the intersection. The first travel time may indicate a turn travel time based on real-time sensor data indicating currently reported traffic condition and traffic speed data at the intersection and driving path on the route across the intersection, i.e., a type of turn to be taken at the intersection.

To determine the turn cost correction factor for the intersection on the route, the turn cost generation module 202a may determine traffic speed data associated with links connected by the intersection. The turn cost generation module 202a may determine the traffic speed data for the intersection using the retrieved map data corresponding to the intersection, the links and the route. In an example, the map data include, but are not limited to, at least one High Definition (HD) map attributes (such as, weather information, real-time traffic flow, real-time traffic incident, road closure and construction information, traffic light SPaT information, recurring congestion information, traffic historical pattern information, road segment attributes), link attributes (such as, link number, link width, link speed limit data), and historical data associated with the links, and dynamic event information.

The turn cost generation module 202a may then determine a second travel time corresponding to the intersection, based on the determined traffic speed data. In accordance with an embodiment, the second travel time may indicate travel time for travelling from a first link to a second link with full drive coverage, wherein the first link is connected to the second link via the intersection. In accordance with an embodiment, the second travel time may be determined based on historical map data and predicted travel speed from each ingress lane(s) to egress lane(s) at the intersection based on the historical travel speed data.

Upon determining the first travel time and the second travel time for the intersection, the turn cost generation module 202a may determine the turn cost correction factor for each ingress lane(s) to egress lane(s) at the intersection. In this regard, the turn cost generation module 202a may calculate a difference between the second travel time and the first travel time at the intersection. In this manner, turn cost correction factor for each of the intersections lying on the route may be determined.

Based on the turn cost correction factor of the intersections on the route, the navigation instructions generation module 202c may update the first navigation instructions and generate an updated ETA and routing instructions based on time for crossing the intersections. In accordance with an embodiment, updating the first navigation instructions may include updating the first ETA based on the turn cost correction factor corresponding to the intersection. In an example, the first ETA may be updated by adding or multiplying the turn cost correction factor for each of the intersections on the route, to the first ETA. In another embodiment, updating the first navigation instructions may include updating traffic condition information at the intersection on a map rendered on a user equipment, updating color codes of the intersections on the map, updating routing message based on traffic conditions of the intersections, and so forth.

In accordance with an embodiment, the turn cost correction factor, the second travel time, travel speed for a given road segment, and the first travel time on the route may be fed to the navigation instructions generation module 202c. Based on the input, the navigation instructions generation module 202c may update navigation instructions of the first vehicle for travelling along the route based on the turn cost correction factor. The first vehicle travelling along the route may cross the intersection in due course of travel. In accordance with an example, the navigation instructions generation module 202c may include an ETA engine. The ETA engine may be configured to determine a first estimated time of arrival (ETA) of the first vehicle, based on the probe data and the map data. Thereafter, the ETA engine may update the first ETA based on the turn cost correction factor for each of the intersections on the route. In accordance with an embodiment, the updating of the first ETA comprises adding or multiplying the turn cost correction factor for each of the intersections to the determined corresponding first ETA.

In accordance with an embodiment, the processor 202 may also store the turn cost correction factor in the map database 106b along with updated navigation instructions and updated ETA, travel time and traffic condition for crossing the intersection at a corresponding given time. Based on the updated navigation instructions and the updated ETA, the routing module 202e may provide the updated navigation instructions and the updated ETA as routing information to the vehicle or a user equipment. In an example, the updated navigation instructions and the updated ETA may then be fed to the routing module 202e. The routing module 202e may be configured to generate user readable or user-understandable routing instructions, such as routing messages, notifications, etc., based on the updated navigation instructions and the updated ETA. The routing module 202e may send or push the routing messages to a user equipment, such as the UE 108, to enable routing of the first vehicle.

The processor 202 may retrieve computer executable instructions that may be stored in the memory 204 for execution of the computer executable instructions. The memory 204 may store the sensor data associated with the plurality of intersection connected links and the at least one intersection on the route for which the navigation instruction may be generated. In accordance with an embodiment, the processor 202 may be configured to retrieve input (such as, real-time sensor data, historical probe data, real-time probe data, map data indicating map attributes associated with the plurality of intersection connected links and the at least one intersection on the route) from background batch data services, streaming data services or third party service providers, and renders output, such as, the turn cost correction factor for the at least one intersection, updated navigation instructions, updated ETA and notification associated with the updated navigation instructions for use by the end user on the UE 108 through the I/O interface 206.

The processor 202 may be embodied in a number of different ways. For example, the processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally or alternatively, the processor 202 may include one or more processors configured in tandem via the bus to enable independent execution of instructions, pipelining and/or multithreading. Additionally or alternatively, the processor 202 may include one or more processors capable of processing large volumes of workloads and operations to provide support for big data analysis. In an example embodiment, the processor 202 may be in communication with the memory 204 via a bus for passing information among components of the system 102.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to carry out various functions in accordance with an example embodiment of the present disclosure. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA or the like, the processor 202 may be specifically configured hardware for conducting the operations described herein.

Alternatively, as another example, when the processor 202 is embodied as an executor of software instructions, the instructions may specifically configure the processor 202 to perform the algorithms and/or operations described herein when the instructions are executed. However, in some cases, the processor 202 may be a processor specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU) and logic gates configured to support operation of the processor 202. The network environment, such as, 100 may be accessed using the I/O interface 206 of the system 102. The I/O interface 206 may provide an interface for accessing various features and data stored in the system 102.

The processor 202 of the system 102 may be configured to determine turn cost correction factor for at least one intersection, based on the sensor data and the map data. The turn cost correction factor may indicate a delta of turn cost based on current dynamic cost and historical cost while crossing the at least one intersection. The processor 202 may be further configured to update navigation instructions for travelling along a route that include the at least one intersection, based on the turn cost correction factor. The processor 202 may be further configured to determine an updated ETA when crossing the at least one intersection, based on the turn cost correction factor of the at least one intersection.

The memory 204 of the system 102 may be configured to store a dataset (such as, but not limited to, the sensor data, the probe data and the map data) associated with the plurality of links and intersections. In accordance with an embodiment, the memory 204 may include processing instructions for generating navigation instructions for travelling across the route. The dataset may include real-time data and historical data, from service providers. The memory 204 of the system 102 may be configured to store the generated turn cost correction factor and the updated navigation instructions.

In some example embodiments, the I/O interface 206 may communicate with the system 102 and displays input and/or output of the system 102. As such, the I/O interface 206 may include a display and, in some embodiments, may also include a keyboard, a mouse, a joystick, a touch screen, touch areas, soft keys, one or more microphones, a plurality of speakers, or other input/output mechanisms. In one embodiment, the system 102 may comprise user interface circuitry configured to control at least some functions of one or more I/O interface elements such as a display and, in some embodiments, a plurality of speakers, a ringer, one or more microphones and/or the like. The processor 202 and/or I/O interface 206 circuitry comprising the processor 202 may be configured to control one or more functions of one or more I/O interface 206 elements through computer program instructions (for example, software and/or firmware) stored on a memory 204 accessible to the processor 202. The processor 202 may further render notification associated with the navigation instructions, such as traffic conditions, ETA, routing information, etc., on the user equipment 108 via the I/O interface 206.

In some embodiments, the processor 202 may be configured to provide Internet-of-Things (IoT) related capabilities to users of the system 102 disclosed herein. The IoT related capabilities may in turn be used to provide smart city solutions by providing real time traffic updates, big data analysis, and sensor-based data collection by using the cloud based mapping system for providing accurate navigation instructions. The I/O interface 206 may provide an interface for accessing various features and data stored in the system 102.

FIG. 2B shows an exemplary format of map data 200b stored in the map database 106b according to one or more example embodiments. FIG. 2B shows a link data record 208 that may be used to store data about one or more lane marking data (referred to as feature links, hereinafter) related to intersection connected links stored in the map database 106b. The link data record 208 has information (such as “attributes”, “fields”, etc.) associated with it that allows identification of an intersection associated with a link and/or the geographic positions (e.g., the latitude and longitude coordinates and/or altitude or elevation) of two intersections. In addition, the link data record 208 may have information (e.g., more “attributes”, “fields”, etc.) associated with it that specify the permitted speed of travel on the portion of the road represented by the link record, the direction of travel permitted on the road portion represented by the link record, what, if any, turn restrictions exist at each of the intersections which correspond to intersections at the ends of a road portion or link represented by the link record, the street address ranges of the roadway portion represented by the link record, the name of the road, and so on. The various attributes associated with a link may be included in a single data record or are included in more than one type of records which are referenced to each other.

Each link data record that represents other-than-straight road segment may include shape point data. A shape point is a location along a link between its endpoints. To represent the shape of other-than-straight roads, the mapping platform 106a and its associated map database 106b developer selects one or more shape points along the other-than-straight road portion. Shape point data included in the link data record 208 indicate the position, (e.g., latitude, longitude, and optionally, altitude or elevation) of the selected shape points along the represented link.

Additionally, in the compiled geographic database, such as a copy of the map database 106b that is compiled and provided to a user interface, there may also be a node data record 210 for each intersection. The node data record 210 may have associated with it information (such as “attributes”, “fields”, etc.) that allows identification of the link(s) that connect to it and/or its geographic position (e.g., its latitude, longitude, and optionally altitude or elevation).

In some embodiments, compiled geographic databases are organized to facilitate the performance of various navigation-related functions. One way to facilitate performance of navigation-related functions is to provide separate collections or subsets of the geographic data for use by specific navigation-related functions. Each such separate collection includes the data and attributes needed for performing the particular associated function, but excludes data and attributes that are not needed for performing the function. Thus, the map data may be alternately stored in a format suitable for performing types of navigation functions, and further may be provided on-demand, depending on the type of navigation function.

FIG. 2C shows another format of the map data 200c stored in the map database 106b according to one or more example embodiments. In the FIG. 2C, the map data 200c is stored by specifying a road segment data record 212. The road segment data record 212 is configured to represent data that represents a road network. In FIG. 2C, the map database 106b contains at least one road segment data record 212 (also referred to as “entity” or “entry”) for each road segment in a geographic region.

The map database 106b that represents a geographic region also includes a node database record (depicted as, a node data record 214a and a node data record 214b) (or “entity” or “entry”) for each intersection associated with the at least one road segment shown by the road segment data record 212. (The terms “intersection” and “segments” represent only one terminology for describing these physical geographic features and other terminology for describing these features is intended to be encompassed within the scope of these concepts). Each of the node data records 214a and 214b may have associated information (such as “attributes”, “fields”, etc.) that allows identification of the road segment(s) that connect to it and/or its geographic position (e.g., its latitude and longitude coordinates).

FIG. 2C shows some of the components of the road segment data record 212 contained in the map database 106b. The road segment data record 212 includes a segment ID 212a by which the data record can be identified in the map database 106b. Each road segment data record 212 has associated with it information (such as “attributes”, “fields”, etc.) that describes features of the represented road segment. The road segment data record 212 may include data 212b that indicate the restrictions, if any, on the direction of vehicular travel permitted on the represented road segment. The road segment data record 212 includes data 212c that indicate a static speed limit or speed category (i.e., a range indicating maximum permitted vehicular speed of travel) on the represented road segment. The static speed limit is a term used for speed limits with a permanent character, even if they are variable in a pre-determined way, such as dependent on the time of the day. The static speed limit is the sign posted explicit speed limit for the road segment, or the non-sign posted implicit general speed limit based on legislation.

The road segment data record 212 may also include data 212d indicating the two-dimensional (“2D”) geometry or shape of the road segment. If a road segment is straight, its shape can be represented by identifying its endpoints or intersections. However, if a road segment is other-than-straight, additional information is required to indicate the shape of the road. One way to represent the shape of an other-than-straight road segment is to use shape points. Shape points are points through which a road segment passes between its end points. By providing the latitude and longitude coordinates of one or more shape points, the shape of an other-than-straight road segment can be represented. Another way of representing other-than-straight road segment is with mathematical expressions, such as polynomial splines.

The road segment data record 212 also includes road grade data 212e that indicate the grade or slope of the road segment. In one embodiment, the road grade data 212e include road grade change points and a corresponding percentage of grade change. Additionally, the road grade data 212e may include the corresponding percentage of grade change for both directions of a bi-directional road segment. The location of the road grade change point is represented as a position along the road segment, such as thirty feet from the end or intersection of the road segment. For example, the road segment may have an initial road grade associated with its beginning intersection. The road grade change point indicates the position on the road segment wherein the road grade or slope changes, and percentage of grade change indicates a percentage increase or decrease of the grade or slope. Each road segment may have several grade change points depending on the geometry of the road segment. In another embodiment, the road grade data 212e includes the road grade change points and an actual road grade value for the portion of the road segment after the road grade change point until the next road grade change point or end intersection. In a further embodiment, the road grade data 212e includes elevation data at the road grade change points and intersections. In an alternative embodiment, the road grade data 212e is an elevation model which may be used to determine the slope of the road segment.

The road segment data record 212 also includes data 212g providing the geographic coordinates (e.g., the latitude and longitude) of the end points of the represented road segment. In one embodiment, the data 212g are references to the node data records 214 that represent the intersection corresponding to the end points of the represented road segment.

The road segment data record 212 may also include or be associated with other data 212f that refer to various other attributes of the represented road segment. The various attributes associated with a road segment may be included in a single road segment record, or may be included in more than one type of record which cross-reference each other. For example, the road segment data record 212 may include data identifying the name or names by which the represented road segment is known, the street address ranges along the represented road segment, and so on.

FIG. 2C also shows some of the components of the node data record 214a and 214b contained in the map database 106b. Each of the node data records 214a and 214b may have associated information (such as “attributes”, “fields”, etc.) that allows identification of the road segment(s) that connect to it and/or it's geographic position (e.g., its latitude and longitude coordinates). For the embodiment shown in FIG. 2C, the node data records 214a and 214b include the latitude and longitude coordinates 214a1 and 214b1 for corresponding intersection. The node data records 214a and 214b may also include other data 214a2 and 214b2 that refer to various other attributes of the intersections. In some embodiments, the node data records 214a and 214b may be associated with at least one first point and at least one second point, which may be border points of a feature line or lane marking and at least one second line in vicinity of the feature line (or at least one first point) respectively.

Thus, the overall data stored in the map database 106b may be organized in the form of different layers for greater detail, clarity and precision. Specifically, in the case of high definition maps, the map data may be organized, stored, sorted and accessed in the form of three or more layers. These layers may include road level layer, lane level layer and localization layer. The data stored in the map database 106b in the formats shown in FIGS. 2B and 2C may be combined in a suitable manner to provide these three or more layers of information. In some embodiments, there may be lesser or fewer number of layers of data also possible, without deviating from the scope of the present disclosure.

FIG. 2D illustrates a block diagram 200d of the map database 106b storing map data or geographic data 216 in the form of road segments/links, intersections, and one or more associated attributes as discussed above. Furthermore, attributes may refer to features or data layers associated with the link-intersection database, such as an HD lane data layer.

In addition, the map data 216 may also include other kinds of data 218. The other kinds of data 218 may represent other kinds of geographic features or anything else. The other kinds of data 218 may include point of interest data. For example, the point of interest data may include point of interest records comprising a type (e.g., the type of point of interest, such as restaurant, hotel, city hall, police station, historical marker, ATM, golf course, etc.), location of the point of interest, a phone number, hours of operation, etc. The map database 106b also includes indexes 220. The indexes 220 may include various types of indexes that relate the different types of data to each other or that relate to other aspects of the data contained in the geographic database 106b.

The data stored in the map database 106b in the various formats discussed above may help in providing precise data for high definition mapping applications, autonomous vehicle navigation and guidance, cruise control using ADAS, direction control using accurate vehicle maneuvering and other such services. In some embodiments, the system 102 accesses the map database 106b storing data in the form of various layers and formats depicted in FIGS. 2B-2D, to retrieve map data 216 or information from the map database 106b. The system 102 may retrieve sensor data, traffic-related information and other information relating to road segment and link topology and geometry.

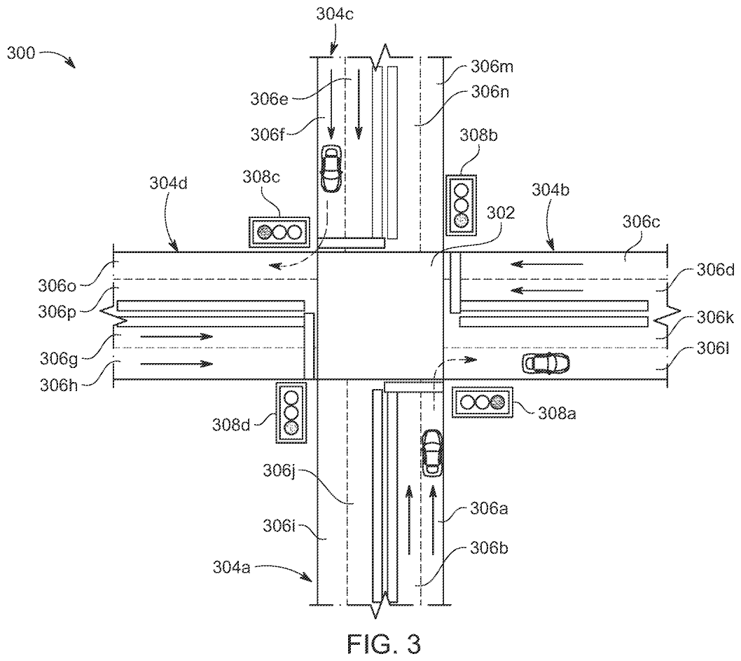

FIG. 3 shows a graphical representation of an exemplary environment 300 where a turn cost correction factor corresponding to an intersection is calculated, in accordance with an example embodiment.

With reference to FIG. 3, the environment 300 includes a four-way intersection 302 that connects four roads (depicted as roads 304a, 304b, 304c and 304d, and collectively referred to as roads 304). As shown in FIG. 3, each of the four roads 304a-304d have two road segments for uplink and downlink traffic, and each of the two road segments have two links or lanes. The links are separated based on lane markings.

In addition, the environment 300 includes four traffic lights (depicted as traffic lights 308a, 308b, 308c and 308d, and collectively referred to as traffic lights 308). Each of the traffic lights 308a-308d correspond to a road segments, i.e., uplink or downlink links of the roads 304. The traffic lights 308 may control movement of traffic from the different links and road segments across the intersection 302.

In an example, the system 102 may receive a routing request from a device, such as a user equipment 108 or a first vehicle. The routing request may include a source location, a destination location, and an estimated time of departure. Based on the source location and the destination location, the system 102 may autonomously determine a route of travel, or a user may select a route of travel. In an example, the route of travel may include the intersection 302.

To address the routing request, the system 102 may determine turn cost correction factor for the intersection and generate navigation instructions for travelling along the route. In this regard, the system 102 determines driving path of the first vehicle from ingress lane(s) to egress lane(s), i.e., a turn to be taken by the first vehicle at the intersection 302 in order to follow the route. In an example, the driving path may indicate rights turn from a first link 306a on the road 304a to a second link 306l on the road 304b.

The system may retrieve sensor data from at least one vehicle probing along the route, the intersection 302, and/or the first link 306a and the second link 306l. As shown, a vehicle 308 may be travelling along the driving path of the first vehicle on the route from the first link 306a to the second link 306l. In accordance with an embodiment, the vehicle 308 may be a probe resource that may send sensor data to the system 102 or a mapping platform 104. The system 102 may also retrieve map data corresponding to the intersection 302, the first link 306a and the second link 306l, and/or the route of the first vehicle.

In order to determine the turn cost correction factor corresponding to the intersection 302, the system 102 may determine intersection information corresponding to the intersection 302, using the sensor data. Based on the intersection information and other sensor data, the system 102 may determine reported traffic speed data for each of the links 306a-306l. In an example, a reported traffic speed of the first link 306a is S1, a reported traffic speed of the second link 306l is S2, a reported traffic speed of the third link 306k is S3, and so forth. In addition, the system 102 may also determine a length of each of the links 306a-306l. In an example, a length of the first link 306a is L1, a length of the second link 306l is L2, a length of the third link 306k is L3, and so forth. In an example, the system 102 determines the length of each of the links 306a-306l using the map data. Thereafter, the system 102 determines a reported real-time first travel time (Tr) across the intersection. In an example, the system 102 determines the first travel time, Tr, as:

Tr=L1/S1+L2/S2 (1)

Continuing further, the system 102 may determine predicted traffic speed data for the first link 306a, the second link 306l and the intersection 302, using the map data. In an example, the system 102 may use road topology and road geometry data to calculate full drive coverage traffic speed across the intersection 302 when making a right turn from the first link 306a to the second link 306l. Based on the full drive coverage traffic speed data and length of the first link 306a and the second link 306l, the system 102 determines a full drive second travel time (Ts).

Once the first travel time and the second travel time are determined, the system 102 determines a turn cost correction factor for the intersection 302. In an example, the system 102 calculates the turn cost correction factor for the intersection 302 as:

Turn cost correction factor (Δ)=Ts−Tr (2)

In a similar manner, turn cost correction factor for each of the intersections lying on the route of the first vehicle may be determined. By calculating the turn cost correction factors, the system 102 may accumulate enough cost correction factors data for different labeled indexes, such as time of day, rush-hour, holidays, weekdays, weekends, etc. Such turn cost correction factors for different intersection types may be stored in a map database, such as the map database 106b, or any other database associated with the system 102. In an example, based on the turn cost correction factor for the intersection 302, time of crossing the intersection 302 from the first link 306a to the second link 306l for a corresponding given time of the day may be updated, thereby enabling more accurate determination of traffic conditions on the intersection 302 and generation of precise navigation instructions.

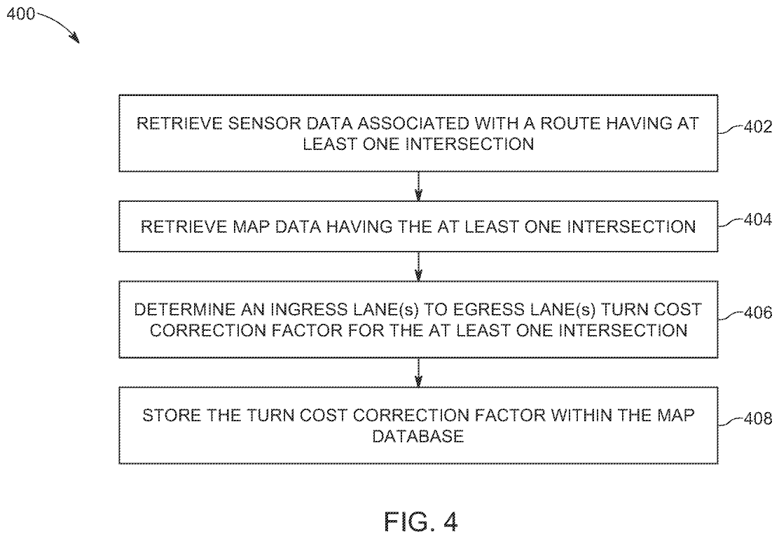

FIG. 4 illustrates a flowchart 400 for implementation of an exemplary method to generate navigation instructions, in accordance with an example embodiment.

At 402, sensor data associated with a route having at least one intersection may be retrieved. The processor 202 may be configured to retrieve the sensor data associated with at least one vehicle travelling along the route. The sensor data may include, but is not limited to, intersection image, intersection video, vehicle-to-vehicle (V2V) data, vehicle-to-infrastructure (V2I) data, traffic light information, stop sign information, traffic sign information, lane marking information, pedestrian image, time stamp, cone, and geolocation data. The sensor data may be indicative of intersection information relating to at least one intersection. The intersection information may include, for example, an intersection category, an intersection type, an intersection identifier, and intersection surrounding condition information.

At 404, map data associated with the route having the at least one intersection may be retrieved. The map data may include information from a map database. The map information may further indicate traffic-related information for a plurality of intersection connected links. It may be noted that some of the plurality of intersection connected links may be a part of the route to be travelled. The map data may include, but is not limited to, HD map attributes associated with a road segment or a road, link attributes, and other dynamic event information, such as road closures and construction information.

At 406, a turn cost correction factor for the at least one intersection may be determined. In this regard, the processor 202 may determine a real-time and currently reported first travel time when crossing the at least one intersection from ingress lane(s) to egress lane(s) based on the sensor data. In addition, the processor 202 may determine a full drive coverage historical second travel time when crossing each ingress lane(s) to egress lane(s) at the at least one intersection based on the map data. Based on a difference between the second travel time and the respective first travel time, the processor 202 may determine the turn cost correction factor for the corresponding intersection.

At 408, the turn cost correction factor may be stored within the map database. In accordance with an embodiment, the processor 202 may update the map database 106b, such as a travel time for crossing the intersection, based on the turn cost correction factor. Based on the updated travel time corresponding to the intersection, the processor 202 may also generate updated navigation instructions. In an example, the updated navigation instructions may include an updated ETA, based on the updated travel time.

Accordingly, blocks of the flowchart 400 support combinations of means for performing the specified functions and combinations of operations for performing the specified functions for performing the specified functions. It will also be understood that one or more blocks of the flowchart 400, and combinations of blocks in the flowchart 400, can be implemented by special purpose hardware-based computer systems which perform the specified functions, or combinations of special purpose hardware and computer instructions.

Alternatively, the system may comprise means for performing each of the operations described above. In this regard, according to an example embodiment, examples of means for performing operations may comprise, for example, the processor 202 and/or a device or circuit for executing instructions or executing an algorithm for processing information as described above.

On implementing the method 400 disclosed herein, the end result generated by the system 102 is a tangible generation of traffic congestion data for a road in a region. The generation of accurate navigation instruction data is of utmost importance to unnecessary delays, specially, in logistics industry.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system for generating navigation instructions, the system comprising:
a memory configured to store computer executable instructions; and
one or more processors configured to execute the instructions to:
retrieve sensor data associated with at least one vehicle travelling along a route having at least one intersection, the sensor data indicating intersection information relating to the at least one intersection, the intersection information comprising at least one of an intersection category and an intersection type;
retrieve map data associated with the route having the at least one intersection, wherein the map data comprises information from a map database, the map data indicating traffic-related information for a plurality of intersection connected links;
based on the sensor data and the map data, determine a turn cost correction factor for the at least one intersection; and
store the turn cost correction factor within the map database

2. The system of claim 1, wherein the one or more processors are further configured to:
update navigation instructions of a first vehicle travelling along the route based on the turn cost correction factor, wherein the first vehicle is to cross the at least one intersection.

3. The system of claim 1, wherein the one or more processors are further configured to:
determine a first estimated time of arrival (ETA) of the vehicle, based on the sensor data and the map data; and
based on the turn cost correction factor for each of the at least one intersection, update the first ETA, wherein updating the first ETA comprises adding or multiplying the turn cost correction factor for each of the at least one intersection to the determined first ETA.

4. The system of claim 1, wherein to determine the turn cost correction factor the one or more processors are further configured to:
determine driving path on a lane level of the first vehicle when crossing the at least one intersection; and
based on the intersection type, the intersection category and the driving path of ingress lane(s) to egress lane(s) connection, determine a first travel time corresponding to each of the at least one intersection.

5. The system of claim 4, wherein to determine the turn cost correction factor the one or more processors are further configured to:
based on the map data, determine traffic speed data associated with a plurality of links connected by the at least one intersection; and
determine a second travel time corresponding to each ingress lane(s) to egress lane(s) connection of the at least one intersection, based on the determined traffic speed data.

6. The system of claim 5, wherein to determine the turn cost correction factor the one or more processors are further configured to:
determine the turn cost correction factor for each ingress lane(s) to egress lane(s) connection of the at least one intersection, based on a difference between the first travel time at the at least one intersection and the second travel time at the corresponding at least one intersection.

7. The system of claim 1, wherein the map data comprises at least one High Definition (HD) map attributes, link attributes, and dynamic event information.

8. The system of claim 1, wherein the sensor data comprises at least one of intersection image, intersection video, vehicle-to-vehicle (V2V) data, vehicle-to-infrastructure (V2I) data, traffic light information, stop sign information, traffic sign information, lane marking information, pedestrian image, time stamp, cone, and geolocation data.

9. The system of claim 1, wherein the one or more processors are further configured to:
update the map database based on the turn cost correction factor.

10. A method of generating navigation instructions, the method comprising:
retrieving sensor data associated with at least one vehicle travelling along a route having at least one intersection, the sensor data indicating intersection information relating to the at least one intersection, the intersection information comprising at least one of an intersection category and an intersection type;
retrieving map data associated with the route having the at least one intersection, wherein the map data comprises information from a map database, the map data indicating traffic-related information for a plurality of intersection connected links;
based on the sensor data and the map data, determining a turn cost correction factor for the at least one intersection; and
storing the turn cost correction factor within the map database.

11. The method of claim 10, the method further comprising:
updating navigation instructions of a first vehicle travelling along the route based on the turn cost correction factor, wherein the first vehicle is to cross the at least one intersection.

12. The method of claim 11, the method further comprising:
determining a first estimated time of arrival (ETA) of the first vehicle, based on the sensor data and the map data; and
based on the turn cost correction factor for each of the at least one intersection, updating the first ETA, wherein updating the first ETA comprises adding or multiplying the turn cost correction factor for each of the at least one intersection to the determined first ETA.

13. The method of claim 10, the method further comprising:
determining driving path on a lane level of the first vehicle when crossing the at least one intersection; and
based on the intersection type, the intersection category and the driving path of ingress lane(s) to egress lane(s) connection, determining a first travel time corresponding to each of the at least one intersection.

14. The method of claim 13, the method further comprising:
based on the map data, determining traffic speed data associated with a plurality of links connected by the at least one intersection; and
determining a second travel time corresponding to each ingress lane(s) to egress lane(s) connection of the at least one intersection, based on the determined traffic speed data.

15. The method of claim 14, the method further comprising:
determining the turn cost correction factor for each ingress lane(s) to egress lane(s) connection of the at least one intersection, based on a difference between the first travel time at the at least one intersection and the second travel time at the corresponding at least one intersection.

16. The method of claim 10, wherein the map data comprises at least one of High Definition (HD) map attributes, link attributes, and dynamic event information.

17. A computer programmable product comprising a non-transitory computer readable medium having stored thereon computer executable instructions, which when executed by one or more processors, cause the one or more processors to carry out operations for generating navigation instructions, the operations comprising:
retrieving sensor data associated with at least one vehicle travelling along a route having at least one intersection, the sensor data indicating intersection information relating to the at least one intersection, the intersection information comprising at least one of an intersection category and an intersection type;
retrieving map data associated with the route having the at least one intersection, wherein the map data comprises information from a map database, the map data indicating traffic-related information for a plurality of intersection connected links;
based on the sensor data and the map data, determining a turn cost correction factor for the at least one intersection; and
storing the turn cost correction factor within the map database.

18. The computer programmable product of claim 17, the operations further comprising:
updating navigation instructions of a first vehicle travelling along the route based on the turn cost correction factor, wherein the first vehicle is to cross the at least one intersection.

19. The computer programmable product of claim 17, the operations further comprising:
determining a first estimated time of arrival (ETA) of the first vehicle, based on the sensor data and the map data;
based on the turn cost correction factor for each of the at least one intersection, updating the first ETA, wherein updating the first ETA comprises adding the turn cost correction factor for each of the at least one intersection to the determined first ETA;
based on the map data, determining traffic speed data associated with a plurality of links connected by the at least one intersection; and
determining a second travel time corresponding to each ingress lane(s) to egress lane(s) connection of the at least one intersection, based on the determined traffic speed data.

20. The computer programmable product of claim 17, the operations further comprising:
determining the turn cost correction factor for each ingress lane(s) to egress lane(s) connection of the at least one intersection, based on a difference between the first travel time at the at least one intersection and the second travel time at the corresponding at least one intersection.
